(19) United States
(12) Patent Application Publication
(10) Pub. No.: US 2019/0031181 A1
(43) Pub. Date: Jan. 31, 2019

(54) Control Methods For An Electric Vehicle Equipped With A Ball-Type Continuously Variable Transmission

(71) Applicant: Dana Limited, Maumee, OH (US)

(72) Inventors: Jeffrey M. David, Leander, TX (US); T. Neil McLemore, Leander, TX (US)

(21) Appl. No.: 16/046,140

(22) Filed: Jul. 26, 2018

Related U.S. Application Data
(60) Provisional application No. 62/538,195, filed on Jul. 28, 2017.

(51) Int. Cl. B60W 20/30; B60W 10/108; F16H 15/50; B60K 6/365; B60K 6/543

(52) U.S. Cl. CPC B60W 20/30; B60W 10/108; F16H 15/503; F16H 2059/147; B60K 6/543; B60Y 2200/92; B60Y 2300/18125; B60K 6/365

(57) ABSTRACT

Provided herein is a vehicle including an engine; a first motor/generator; a second motor/generator; a variator; and a controller configured to detect an energy dissipation mode of operation, wherein the controller commands a change in the variator ratio based on the energy dissipation mode.

### RELATED APPLICATION

The present application claims priority to U.S. Provisional patent application Ser. No. 62/538,195, filed on Jul. 28, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations could for example, multiply input torque across the different transmission stages in different manners to achieve the same final drive ratio. However, some configurations provide more flexibility or better efficiency than other configurations providing the same final drive ratio.

Hybrid and electric vehicles typically recover kinetic energy through a regenerative braking process. Friction brakes can be sized/downsized based on the assumption that the battery will have storage capacity for the energy that is recovered. Should that storage capacity be unavailable, the base braking system may be inadequate or overheat. A method is needed to dissipate excess energy in the scenario where the battery is full, faulted, temperature limited, or otherwise compromised.

### SUMMARY

Provided herein is a vehicle including: an engine; a first motor/generator; a second motor/generator; a variator; and a controller configured to detect an energy dissipation mode of operation; and wherein the controller commands a change in the variator ratio based on the energy dissipation mode.

Provided herein is a method for controlling an electric hybrid vehicle having an engine, a first motor/generator, a second motor/generator, and a variator, the method including the steps of: receiving a plurality of data signals provided by sensors located on the transmission, the plurality of data signals including: a variator ratio, a motor/generator temperature, a motor/generator speed, a battery temperature, and a battery power; detecting an energy dissipation condition based on the data signals; determining a regenerative brake torque request; determining a variator torque dissipation request; determining a variator ratio command based on the regenerative brake torque request and the variator torque dissipation request; and commanding the variator to operate at the target variator ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a top level block diagram of the input/output interfaces to the hybrid supervisory controller.

FIG. 5 is a block diagram depicting an electric hybrid powertrain having an engine, two motor/generators, and a variator.

FIG. 6 is a representative chart of energy dissipation opportunity for the variator of FIG. 1 as a function of normalized speed and speed ratio.

FIG. 7 is a flow chart depicting an enable energy dissipation mode process that is implementable in the hybrid supervisory controller of FIG. 4.

FIG. 8 is a flow chart depicting an energy dissipation control process that is implementable in the hybrid supervisory controller of FIG. 4.

FIG. 9 is a schematic diagram of an exemplary full toroidal variator.

FIG. 10 is a schematic diagram of an exemplary half toroidal variator.

FIG. 11 is schematic diagram of an exemplary belt-and-pulley variator.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller could be configured to receive input signals indicative of parameters associated with an engine coupled to the transmission. The parameters could include throttle position sensor values, accelerator pedal position sensor values, vehicle speed, gear selector position, user-selectable mode configurations, and the like, or some combination thereof. The electronic controller could also receive one or more control inputs. The electronic controller could determine an active range and an active variator mode based on the input signals and control inputs. The electronic controller could control a final drive ratio of the variable ratio transmission by controlling one or more electronic actuators and/or solenoids that control the ratios of one or more portions of the variable ratio transmission.

In some embodiments, the electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

Some embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque.

Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT includes a processor (not shown).

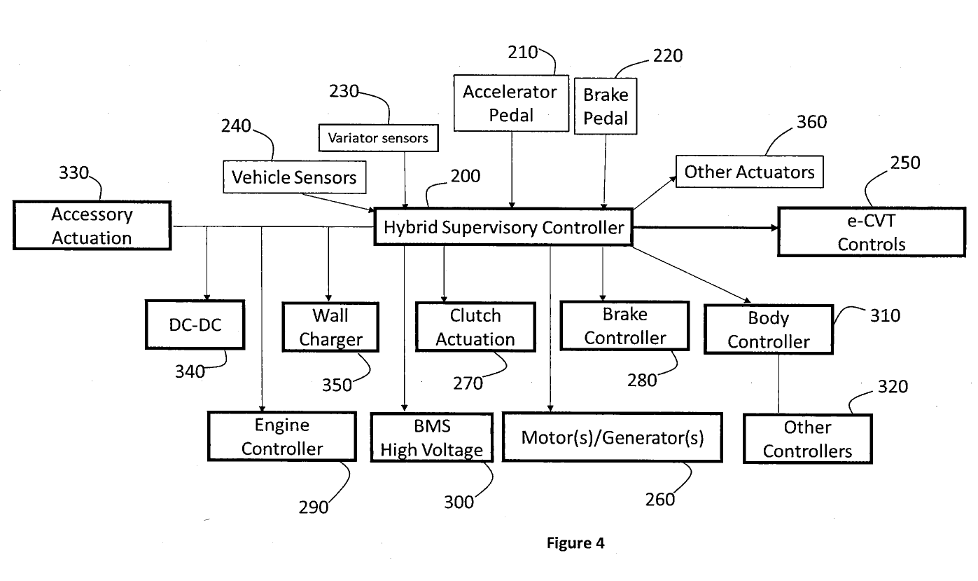

Referring now to FIG. 4, in some embodiments, control methods described herein are implementable in a hybrid supervisory controller 200 that is adapted to receive a plurality of input signals obtained from sensors equipped on an electric hybrid vehicle, and deliver a plurality of output signals to actuators and controllers provided on the vehicle. Illustrative examples of the hybrid supervisory controller 200 are described in U.S. patent application Ser. No. 16/062,400, which is hereby incorporated by reference. For example, the hybrid supervisory controller 200 is configured to receive signals from an accelerator pedal position sensor 210, a brake pedal position sensor 220, and a number of variator sensors 230. The variator sensors 230 optionally include input speed sensors, actuator position sensor, temperature sensors, and torque sensors, among others. The hybrid supervisory controller 200 receives a number of input signals from vehicle sensors 240. For example, the vehicle sensors 240 include, but are not limited to, battery state of charge (SOC), motor speed sensor, generator speed sensor, engine speed sensor, engine torque sensor, and a number of temperature sensors, among others. The hybrid supervisory controller 200 performs a number of calculations based at least in part on the input signals to thereby generate the output signals. The output signals are received by a number of control modules equipped on the vehicle. For example, the hybrid supervisory controller 200 is configured to communicate with a CVT control module 250, a motor/generator control module 260, a clutch actuator module 270, a brake control module 280, an engine control module 290, a battery management system (BMS) high voltage control module 300, a body control module 310, among other control modules 320 equipped on the vehicle. It should be appreciated that the motor/generator/inverter control module 260 is optionally configured with a number of submodules to perform control functions for those components. The hybrid supervisory controller 200 is adapted to be in communication with an accessory actuator module 330. In some embodiments, the hybrid supervisory controller 200 is optionally configured to communicate with a DC-DC inverter module 340 and a wall charger module 350, among other actuator control modules 360. It should be appreciated that the hybrid supervisory controller 200 is adapted to communicate with a number of vehicle controllers via CAN interface or direct electric connection. In some embodiments, the hybrid supervisory controller 200 is adapted to interface with a typical electric grid configured to supply electrical energy from a source to a consumer.

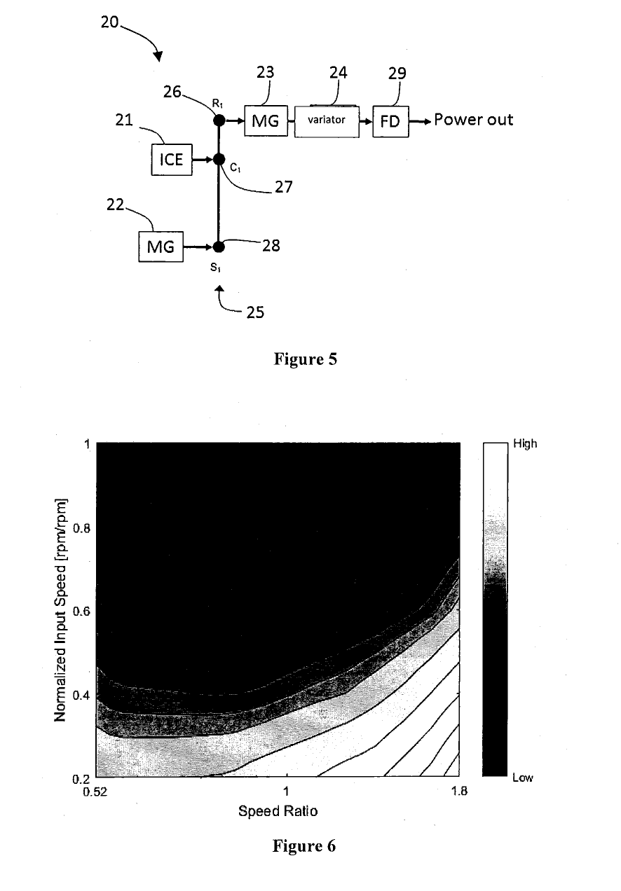

Referring now to FIGS. 5-8, hybrid and electric vehicles typically recover kinetic energy through a regenerative braking process. Friction brakes can be sized/downsized based on the assumption that the battery will have storage capacity for the energy that is recovered. Should that storage capacity be unavailable, the base braking system may be inadequate or overheat. A method is needed to dissipate excess energy in the scenario where the battery is full, faulted, temperature limited, or otherwise compromised.

Provided herein is a control method where the variator is intentionally operated in an inefficient manner to purposefully dissipate excess kinetic energy. In some embodiments having a ball-type CVP or other traction type transmission such as a toroidal type of transmission, kinetic energy is dissipated through the contact patch between contacting components of the respective transmissions.

Provided herein is a braking control algorithm that generates an energy dissipation request from a braking request and available regen and friction brake capacities.

Provided herein is a braking control algorithm that specifically requests a variator ratio command targeted towards a suboptimal variator efficiency region.

Provided herein is a braking control algorithm that monitors variator fluid temperature to prevent overheating the transmission during energy dissipation mode.

Provided herein is a braking control algorithm that monitors electric motor temperature to enable energy dissipation mode.

Provided herein is a braking control algorithm that monitors battery temperature to enable energy dissipation mode.

Provided herein is a braking control algorithm that monitors battery power limits to enable energy dissipation mode.

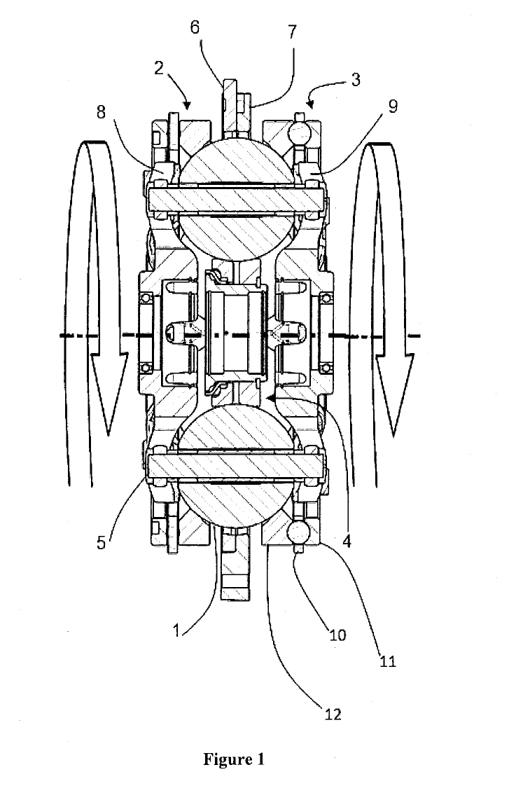

Turning now to FIG. 5, in some embodiments, an electric hybrid powertrain 20 includes an engine 21, a first motor/generator 22, a second motor/generator 23, and a variator 24 similar to the variator described in FIGS. 1-3.

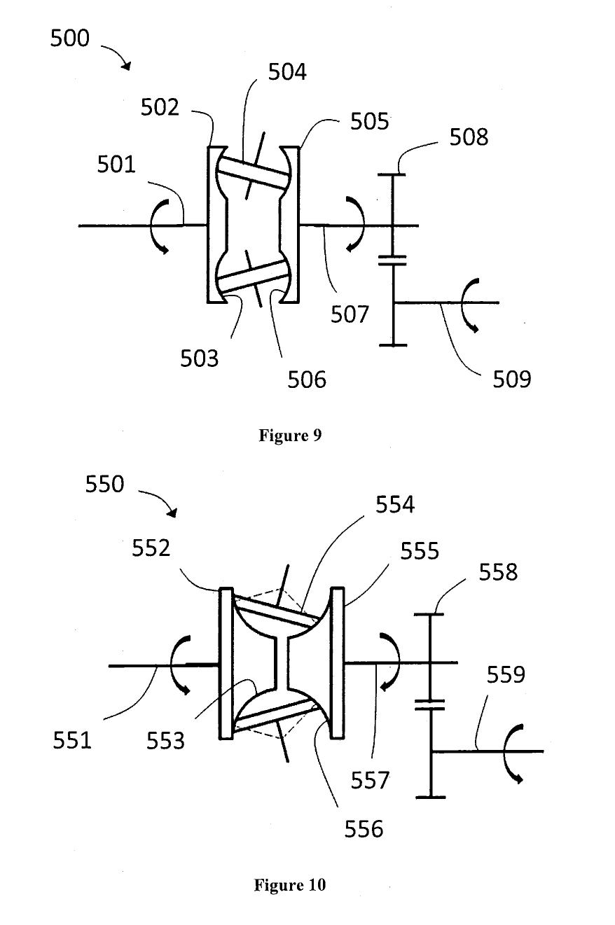

In some embodiments, the variator 24 is similar to the variator described in FIG. 9.

In some embodiments, the variator 24 is similar to the variator described in FIG. 10.

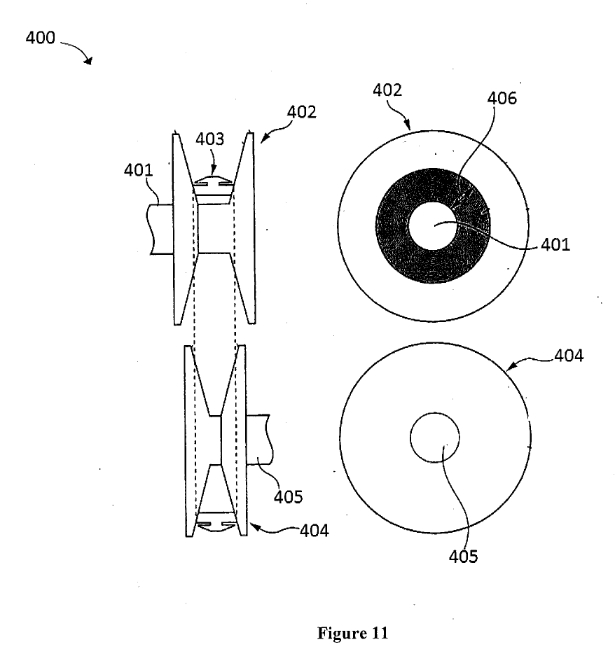

In other embodiments, the variator 24 is similar to the variator described in FIG. 11.

The electric hybrid powertrain 20 has a planetary gear set 25 having a ring gear 26 operably coupled to the second motor/generator 23, a planet carrier 27 operably coupled to the engine 21, and a sun gear 28 operably coupled to the first motor/generator 21.

In some embodiments, the second motor/generator 23 is operably coupled to the variator 24. The variator 24 is configured to transmit an output power to a final drive gear 29. It should be appreciated that a variety of configuration for coupling the variator 24 to the second motor/generator 23 are known. As illustrative example, electric hybrid powertrains are disclosed in U.S. patent Ser. No. 15/760,653; 15/760,647; and Ser. No. 15/774,628, which are hereby incorporated by reference.

Referring now to FIG. 6, given that under certain operating conditions the variator, for example, the CVP depicted in FIGS. 1-3 exhibits inefficiency, an active control method described herein is implemented to use the inherent waste heat generation of the variator to positive advantage. FIG. 6 is a chart depicting CVP energy dissipation opportunity as a function of normalized input speed to the CVP and CVP ratio for a given input torque. In other words, the operating conditions at the full overdrive and full underdrive are the areas of energy dissipation opportunity to dissipate excess energy in the scenario where the battery is full, faulted, temperature limited, or otherwise compromised.

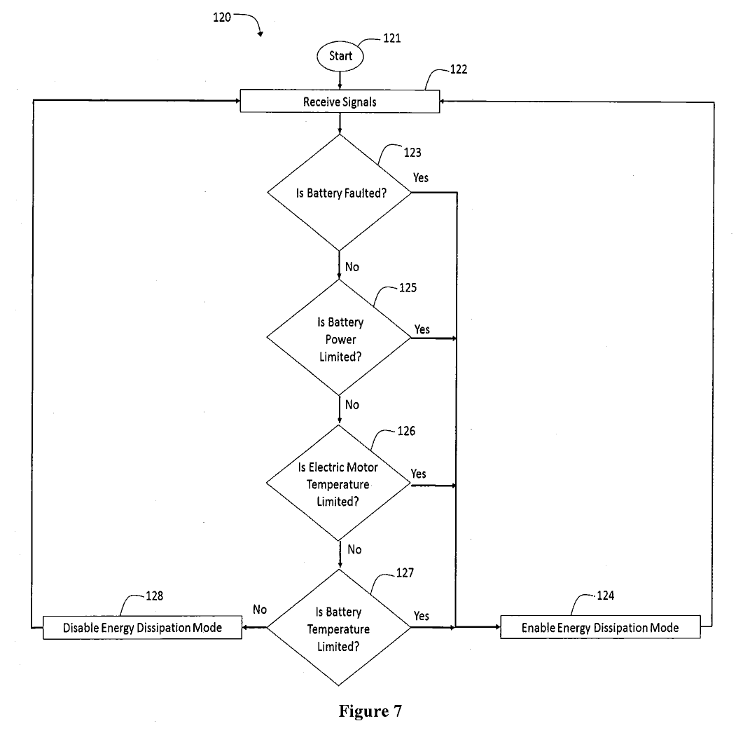

Turning now to FIG. 7, in some embodiments, an enable energy dissipation mode process 120, sometimes referred to herein as “the enable process 120”, is implemented in the hybrid supervisory controller 200 in order to detect conditions where energy dissipation through the variator is needed. The enable process 120 begins at a start state 121 and proceeds to a block 122 where a number of signals are received from the vehicle sensors 240, the variator sensors 230, accelerator pedal 210, and brake pedal 220, among others. The enable process 120 proceeds to a first evaluation block 123 where the battery system is evaluated for any fault conditions. When the first evaluation block 123 returns a true result, indicating that the battery system has a fault condition, the enable process 120 proceeds to the block 124 where an enable command is sent to other modules in the hybrid supervisory controller 200 to enable an energy dissipation mode of operation. When the first evaluation block 123 returns a false result, indication that there are no faults in the battery system, the enable process 120 proceeds to a second evaluation block 125. The second evaluation block 125 determines if the battery or battery system is power limited and unable to accept the amount of power that is being supplied from the motors during regeneration. When the second evaluation block 125 returns a true result, the enable process 120 proceeds to the block 124. When the second evaluation block 125 returns a false result, the enable process 120 proceeds to a third evaluation block 126. The third evaluation block 126 determines if electric motors in the powertrain are temperature limited. When the third evaluation block 126 returns a true result, the enable process 120 proceeds to the block 124. When the third evaluation block 126 returns a false result, the enable process 120 proceeds to a fourth evaluation block 127. The fourth evaluation block 127 determines if the battery or battery system is temperature limited. When the fourth evaluation block 127 returns a true result, the enable process 120 proceeds to the block 124. When the fourth evaluation block 127 returns a false result, the enable process 120 proceeds to a block 128 where the energy dissipation mode is disable. The enable process 120 returns to the block 122.

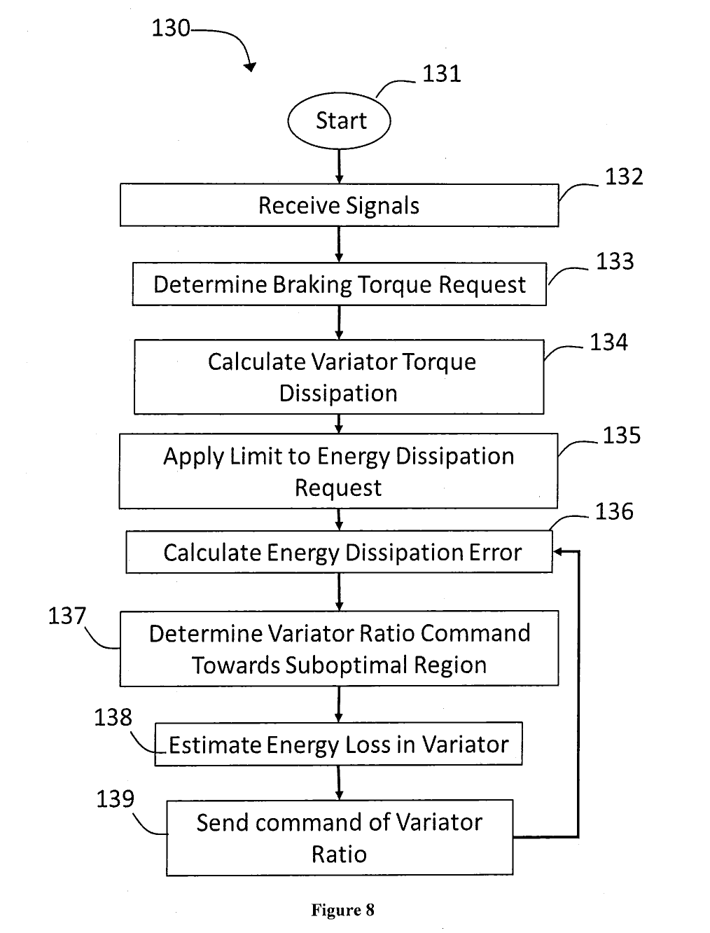

Referring now to FIG. 8, in some embodiments, an energy dissipation control process 130 is implementable in the supervisory hybrid controller 200. In some embodiments, the energy dissipation control process 130 is activated by the block 124 of the enable process 120. The energy dissipation control process 130 begins at a start state 131 and proceeds to a block 132 where a number of signals are received from the supervisory hybrid controller 200.

In some embodiments, the signals include a battery power limit, a battery temperature, and a brake torque request. The energy dissipation control process 130 proceeds to a block 133 where a regenerative braking control algorithm generates a braking torque request based on the signals received. The energy dissipation control process 130 proceeds to a block 134 where a variator torque dissipation request is determined based on the brake torque request and available torque capacity of other elements in the powertrain. For example, the variator torque dissipation request is determined from the following expressions: T_{dissipation}=T_{brake}_{_}_{request}−T_{regen}_{_}_{cap}−T_{friction}_{_}_{cap}; where T_{dissipation} is the variator torque dissipation request, T_{brake}_{_}_{request} is the brake torque request, T_{regen}_{_}_{cap} is the regeneration torque capacity of the powertrain, T_{friction}_{_}_{cap} is the friction torque capacity in the powertrain. The energy dissipation control process 130 proceeds to a block 135 where limits on the energy dissipation request due to fluid temperature or other thermal factors are applied. The energy dissipation control process 130 proceeds to a block 136 where an energy dissipation error is calculated using the expressions Error=T_{dissipation}−T_{dissipation}_{_}ₑₛₜ, where T_{dissipation} is the variator torque dissipation request, and T_{dissipation}_{_}ₑₛₜ is the estimated variator energy dissipation, which is calculated in the block 138. The energy dissipation control process 130 proceeds to a block 137 where a variator ratio command is determined based on the calculated error.

In some embodiments, the variator ratio command moves the variator to a suboptimal operating region in terms of variator efficiency. The energy dissipation control process 130 proceeds to a block 138 where energy loss in the variator is estimated using a variator efficiency model programmed in the hybrid supervisory controller 200.

In some embodiments, the variator efficiency model is based on the input speed, input torque, and the variator ratio. The energy dissipation control process 130 proceeds to a block a block 139 where commands are sent to adjust the variator to the variator ratio command determined in the block 137. It should be appreciated, that the energy dissipation control process 130 runs in a loop while enabled and is disabled when the entry criteria from process 120 are no longer met.

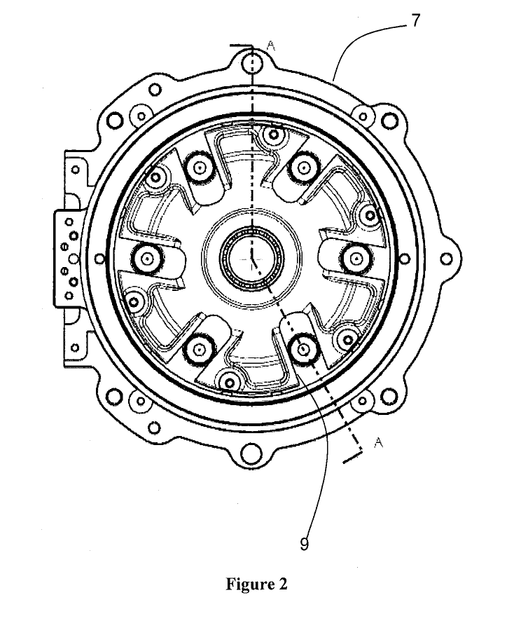

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input traction ring assembly 2 and output traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

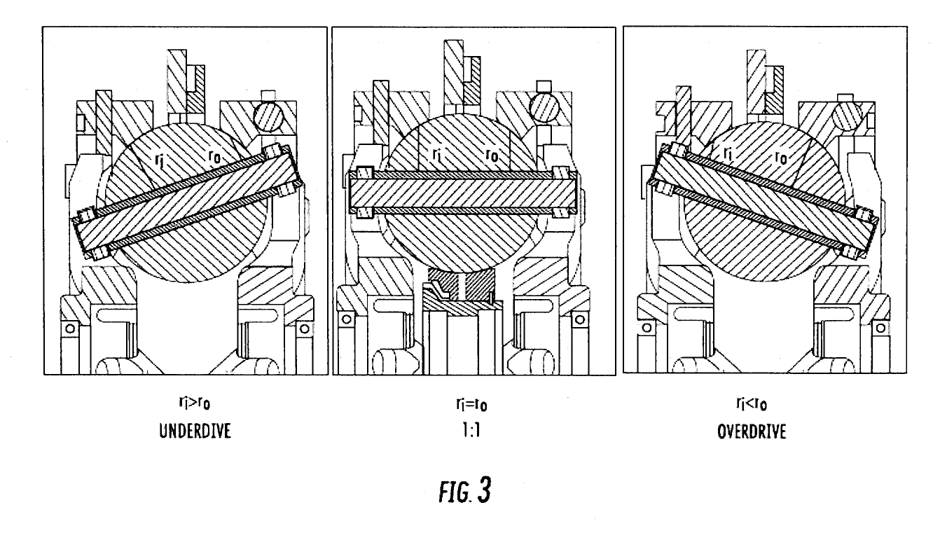

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler.

Referring now to FIG. 9, as an illustrative example of a full toroidal continuously variable transmission, a full toroidal variator 500 is provided with an input shaft 501 coupled to a first traction disc 502. The first traction disc 502 is provided with a first curved raceway 503 adapted to engage a number of traction rollers 504. Each traction roller 504 is provided with a tiltable axis of rotation. The full toroidal variator 500 is provided with a second traction disc 505 having a second curved raceway 506. The first curved raceway 506 and the second curved raceway 507 may take on a variety of shapes, and are semicircular when viewed in the plane of the page of FIG. 9. The second traction disc 505 is coupled to a shaft 507. Since the direction of rotation of the input shaft 501 is opposite of the direction of rotation of the shaft 507, a transfer gear set 508 is coupled to the shaft 507 to transmit power to an output shaft 509. The output shaft 509 rotates in the same direction as the input shaft 501.

Referring now to FIG. 10, as an illustrative example of a half toroidal continuously variable transmission, a half toroidal variator 550 is provided with an input shaft 551 coupled to a first traction disc 552. The first traction disc 552 is provided with a first curved raceway 553 adapted to engage a number of traction rollers 554. It should be noted that the first curved raceway 553. Each traction roller 554 is provided with a tiltable axis of rotation. The full toroidal variator 550 is provided with a second traction disc 555 having a second curved raceway 556. The first curved raceway 556 and the second curved raceway 557 may take on a variety of shapes, and are quarter circular when viewed in the plane of the page of FIG. 10. The second traction disc 555 is coupled to a shaft 557. Since the direction of rotation of the input shaft 551 is opposite of the direction of rotation of the shaft 557, a transfer gear set 558 is coupled to the shaft 557 to transmit power to an output shaft 559. The output shaft 559 rotates in the same direction as the input shaft 351.

Referring now to FIG. 11, as an illustrative example of a belt-and-pulley type of continuously variable transmission, a belt-and-pulley variator 400 includes an input shaft 401, a first pulley 402 coupled to a second pulley 404 with a belt 403. An output shaft 405 is coupled to the second pulley 404. During operation, adjustment of the engagement surface between the belt 403 and the first pulley 401, and in some embodiments, the second pulley 404, through a range 406 provides a variable ratio of operating speed between the input shaft 401 and the output shaft 405. The input shaft 401 and the output shaft 405 have the same direction of rotation.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein could be employed in practicing the preferred embodiments. It is intended that the following claims define the scope of the preferred embodiments and that methods and structures within the scope of these claims and their equivalents be covered thereby.

What is claimed is:

1. A vehicle comprising:
an engine;
a first motor/generator;
a second motor/generator;
a variator; and a
a controller configured to detect an energy dissipation mode of operation,
wherein the controller commands a change in the variator ratio based on the energy dissipation mode.

2. The vehicle of claim 1, further comprising planetary gear set having a ring gear, a planet carrier, and a sun gear, wherein the planet carrier is operably coupled to the engine, the ring gear is coupled to the second motor/generator, and the sun gear is coupled to the first motor/generator.

3. The vehicle of claim 2, wherein the variator is operably coupled to the second motor/generator.

4. The vehicle of claim 3, wherein the controller is configured to adjust the variator ratio to operate at a suboptimal condition to dissipate energy through the variator.

5. The vehicle of claim 1, wherein the energy dissipation mode of operation is detected based on a fault condition of a battery.

6. The vehicle of claim 1, wherein the energy dissipation mode of operation is detected based on a temperature limit of the first motor/generator.

7. The vehicle of claim 1, wherein the energy dissipation mode of operation is detected based on a battery temperature limit.

8. The vehicle of claim 1, wherein the energy dissipation mode of operation is detected based on a battery power limit.

9. A method for controlling an electric hybrid vehicle having an engine, a first motor/generator, a second motor/generator, and a variator, the method comprising the steps of:
receiving a plurality of data signals provided by sensors located on the vehicle, the plurality of data signals comprising:
a variator ratio,
a motor/generator temperature,
a motor/generator speed,
a battery temperature, and
a battery power;
detecting an energy dissipation condition based on the data signals;
determining a regenerative brake torque request;
determining a variator torque dissipation request;
determining a variator ratio command based on the regenerative brake torque request and the variator torque dissipation request; and
commanding the variator to operate at the target variator ratio.

10. The method of claim 9, wherein determining a variator torque dissipation request further comprises estimating a variator efficiency based on the variator ratio, a variator input speed, and a variator input torque.

11. The method of claim 9, wherein determining a variator ratio command further comprises determining an error between the variator torque dissipation request and the estimated variator efficiency.
